(19) United States
(12) Patent Application Publication
(10) Pub. No.: US 2026/0282163 A1
(43) Pub. Date: Sep. 17, 2026

(54) RANDOM ACCESS (RA)-RELATED TRANSMISSIONS

(71) Applicant: Nokia Technologies Oy, Espoo (FI)

(72) Inventors: Samuli Heikki TURTINEN, Oulu (FI); Chunli WU, Beijing (CN); Matha DEGHEL, Massy (FR); Timo KOSKELA, Oulu (FI)

(21) Appl. No.: 19/168,178

(22) PCT Filed: Apr. 4, 2023
(86) PCT No.: PCT/CN2023/086330

§ 371 Date: Sep. 23, 2025

(51) Int. Cl. H04W 76/38; H04W 72/21; H04W 74/0836

(52) U.S. Cl. CPC H04W 76/38; H04W 72/21; H04W 74/0836

(57) ABSTRACT

Example embodiments of the present disclosure relate to applying timing advance during random access procedure. A first apparatus receives, from a second apparatus, first message indicating a first timing advance group (TAG) corresponding to a first timing advance (TA) and a second TAG corresponding to a second TA, the first and second TAGs associated with a serving cell of the first apparatus. The first apparatus further receives, during a random access (RA) procedure a second message comprising a timing advance command (TAC) indicating a third TA. Then, first apparatus performs RA-related transmissions.

### FIELDS

Various example embodiments of the present disclosure generally relate to the field of telecommunication and in particular, to methods, devices, apparatuses and computer readable storage medium for random access (RA)-related transmissions.

### BACKGROUND

Technology of multiple input multiple output (MIMO) has been widely used in current wireless communication system, where a large number of antenna elements are used by a network device for communicating with a terminal device for both sub-6 GHZ and over-6 GHz frequency bands. Further, in order to improve the reliability and robustness of the communication between the network device and the terminal device, technology of multi-transmission and reception point (multi-TRP) has been proposed and discussed.

In case of multi-TRP, the terminal device may be configured with a serving cell, where the serving cell may be associated with more than one timing advance group (TAG). That is, more than one timing advance (TA) is configured to the terminal device. Generally speaking, the terminal device may receive timing advance command (TAC) during an RA procedure, and the RA-related transmissions may need to be performed. However, due to the above discussed multi-TA scenario, the terminal device is confused about the selection of TA. If the TA used by the terminal device is improper, the communication quality of the following RA-related transmissions will be decreased. In view of this, how to perform the RA-related transmissions with a proper TA is desirable to be further discussed.

### SUMMARY

In a first aspect of the present disclosure, there is provided a first apparatus. The first apparatus comprises at least one processor; and at least one memory storing instructions that, when executed by the at least one processor, cause the first apparatus at least to perform: receiving, from a second apparatus, first message indicating a first TAG corresponding to a first TA and a second TAG corresponding to a second TA, the first and second TAGs associated with a serving cell of the first apparatus; receiving, during an RA procedure a second message comprising TAC indicating a third TA; performing RA-related transmissions by using the third TA or by using a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In a second aspect of the present disclosure, there is provided a second apparatus. The second apparatus comprises at least one processor; and at least one memory storing instructions that, when executed by the at least one processor, cause the second apparatus at least to perform: transmitting, to a first apparatus, first message indicating a first TAG corresponding to a first TA and a second TAG corresponding to a second TA, the first and second TAGs associated with a serving cell of the first apparatus; transmitting, during an RA procedure, a second message comprising TAC indicating a third TA; receiving RA-related transmissions by using the third TA or a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In a third aspect of the present disclosure, there is provided a method. The method comprises: at a first apparatus, receiving, from a second apparatus, first message indicating a first TAG corresponding to a first TA and a second TAG corresponding to a second TA, the first and second TAGs associated with a serving cell of the first apparatus; receiving, during an RA procedure a second message comprising TAC indicating a third TA; performing RA-related transmissions by using the third TA or by using a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In a fourth aspect of the present disclosure, there is provided a method. The method comprises: at a second apparatus, transmitting, to a first apparatus, first message indicating a first TAG corresponding to a first TA and a second TAG corresponding to a second TA, the first and second TAGs associated with a serving cell of the first apparatus; transmitting, during an RA procedure, a second message comprising TAC indicating a third TA; receiving RA-related transmissions by using the third TA or a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In a fifth aspect of the present disclosure, there is provided a first apparatus. The first apparatus comprises means for receiving, from a second apparatus, first message indicating a first TAG corresponding to a first TA and a second TAG corresponding to a second TA, the first and second TAGs associated with a serving cell of the first apparatus; means for receiving, during an RA procedure a second message comprising TAC indicating a third TA; means for performing RA-related transmissions by using the third TA or by using a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In a sixth aspect of the present disclosure, there is provided a second apparatus. The second apparatus comprises means for transmitting, to a first apparatus, first message indicating a first TAG corresponding to a first TA and a second TAG corresponding to a second TA, the first and second TAGs associated with a serving cell of the first apparatus; means for transmitting, during an RA procedure, a second message comprising TAC indicating a third TA; means for receiving RA-related transmissions by using the third TA or a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates signaling chart of RA-related transmissions according to some example embodiments of the present disclosure;

FIG. 3 illustrates a flowchart of a method implemented at a first device according to some example embodiments of the present disclosure;

FIG. 4 illustrates a flowchart of a method implemented at a second device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “TRP” may refer to an antenna port or an antenna array (with one or more antenna elements) available to the network device located at a specific geographical location. For example, a network device may be coupled with multiple TRPs in different geographical locations to achieve better coverage. Alternatively, or in addition, multiple TRPs may be incorporated into a network device, or in other words, the network device may comprise the multiple TRPs. The term “TRP” may be also referred to as a cell, such as a macro-cell, a small cell, a pico-cell, a femto-cell, a remote radio head, a relay node, etc. It is to be understood that the term “TRP” may refer to a logical concept which may be physically implemented by various manner. For example, a TRP may refer to or corresponding to a physical cell identity (PCI) or control resource set (CORESET) Pool Index (CORESETPoolIndex) or uplink reference signal set or a TAG. In example embodiments of the present disclosure, the term “TRP” can be used interchangeably with the terms “PCI”, “CORESETPoolIndex”, “TAG”. Therefore, example embodiments described with respect to the TRPs can be applied to PCIs, CORESETPoolIndexes, TAGs.

In some example embodiments of the present disclosure, a PCI may be associated with a TRP in any suitable manner. For example, the PCI associated with the TRP may represent the TRP or correspond to the TRP. For another example, the PCI associated with the TRP may be a PCI of a cell to which the TRP belongs, or a cell within which the TRP is located, or a cell associated with TRP.

In some example embodiments of the present disclosure, a CORESETPoolIndex may be associated with a TRP in any suitable manner. For example, the CORESETPoolIndex associated with the TRP may be a CORESETPoolIndex of a control resource configured for the TRP.

In some example embodiments of the present disclosure, a TAG may be associated with a TRP in any suitable manner. For example, the TAG associated with the TRP may be a TAG to which a cell belongs, where the TRP belongs to the cell, or is located within the cell, or is associated with the cell.

As discussed above, MIMO has been widely used in current wireless communication system. Specifically, MIMO is one of the key technologies in the NR systems and is successful in commercial deployment. In release-15/16/17 of 3GPP, MIMO features were investigated and specified for both frequency division duplexing (FDD) and time division duplexing (TDD) systems, of which major parts were for downlink MIMO operation.

In release-18 of 3GPP, it is important to identify and specify necessary enhancements for uplink MIMO, while necessary enhancements on downlink MIMO that facilitate the use of large antenna array, not only for frequency range (FR) 1 but also for FR2, would still need to be introduced to fulfil the request for evolution of NR deployments. This comprises the following areas of enhancement.

First, significant loss of performance for a UE at high/medium speed has been observed in commercial deployments especially in multi-user MIMO (MU-MIMO) scenarios. As the performance loss is partly caused by outdated channel state information (CSI), enhancements on CSI acquisition to alleviate such loss can be beneficial.

Second, the unified transmission configuration indicator (TCI) framework was introduced in release-17 which facilitates streamlined multi-beam operation targeting FR2. As release-17 focuses on single-TRP use cases, extension of unified TCI framework that focuses on multi-TRP use cases is beneficial.

Third, due to the increasing need for multiplexing capacity of downlink and uplink demodulation reference signal (DMRS) from various use cases, there is a need for increasing the number of orthogonal ports for DMRS.

Fourth, features for facilitating multi-TRP deployments have been introduced in Release 16/17 focusing on non-coherent joint transmission (NC-JT). As coherent joint transmission (CJT) improves coverage and average throughput in commercial deployments with high-performance backhaul and synchronization, enhancement on CSI acquisition for FDD and TDD, targeting FR1, can be beneficial in expanding the utility of multi-TRP deployments.

Fifth, as advanced UEs (for example, CPE, fixed wireless access (FWA), vehicle, industrial devices) become more relevant, introducing necessary enhancements to support for 8 antenna ports as well as 4 and more layers for uplink (UL) transmission can offer the needed improvement for UL coverage and average throughput.

Sixth, with the introduction of features for UL panel selection in Release 17, advanced UEs (for example, CPE, FWA, vehicle, industrial devices) can benefit from higher UL coverage and average throughput with simultaneous UL multi-panel transmission. Finally, some further enhancement to facilitate UL multi-TRP deployments via two TAs and enhanced UL power control can offer additional UL performance improvement.

Further, in release 18, more enhancements for multi-TRP scenario are expected. In one example, it is expected to study CSI reporting enhancement for high/medium UE velocities by exploiting time-domain correlation/Doppler-domain information to assist DL precoding, targeting FR1, as follows: release-16/17 Type-II codebook refinement, without modification to the spatial and frequency domain basis; and UE reporting of time-domain channel properties measured via CSI-RS for tracking.

In another example, it is expected to study extension of Release 17 Unified TCI framework for indication of multiple DL and UL TCI states focusing on multi-TRP use case, using Release 17 unified TCI framework.

In a further example, it is expected to study larger number of orthogonal DMRS ports for downlink and uplink MU-MIMO (without increasing the DM-RS overhead), only for CP-OFDM. Specifically, strive for a common design between DL and UL DMRS, and support up to 24 orthogonal DM-RS ports, where for each applicable DMRS type, the maximum number of orthogonal ports is doubled for both single- and double-symbol DMRS.

In a further example, it is expected to study enhancements of CSI acquisition for CJT targeting FR1 and up to 4 TRPs, assuming ideal backhaul and synchronization as well as the same number of antenna ports across TRPs, as follows:
release 16/17 Type-II codebook refinement for CJT multi-TRP targeting FDD and its associated CSI reporting, taking into account throughput-overhead trade-off;
SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences.

Further, the maximum number of CSI-RS ports per resource remains the same as in Release 17, i.e., 32.

In a further example, it is expected to study UL DMRS, SRS, SRI, and transmit precoding matrix indicator (TPMI) (including codebook) enhancements to enable 8 Tx UL operation to support 4 and more layers per UE in UL targeting CPE/FWA/vehicle/Industrial devices.

In a further example, it is expected to study the following items to facilitate simultaneous multi-panel UL transmission for higher UL throughput/reliability, focusing on FR2 and multi-TRP, assuming up to 2 TRPs and up to 2 panels, targeting CPE/FWA/vehicle/industrial devices (if applicable):
UL precoding indication for PUSCH, where no new codebook is introduced for multi-panel simultaneous transmission. The total number of layers is up to four across all panels and total number of codewords is up to two across all panels, considering single DCI and multi-DCI based multi-TRP operation.

UL beam indication for physical uplink control channel (PUCCH)/physical uplink shared channel (PUSCH), where unified TCI framework extension is expected, considering single downlink control information (DCI) and multi-DCI based multi-TRP operation. For the case of multi-DCI based multi-TRP operation, only for a combination of PUSCH and PUSCH, or a combination PUCCH and PUCCH is transmitted across two panels in a same component carrier (CC).

In a further example, it is expected to Study, and if justified, specify the following: Two TAs for UL multi-DCI for multi-TRP operation, power control for UL single DCI for multi-TRP operation where unified TCI framework extension in objective 2 is assumed.

In summary, operations under the multi-TRP scenario are technical focus. In this present disclosure, a solution of related transmissions is proposed for a scenario where the at least two TA values are configured for a UE within a serving cell. Some related-technical implementations are listed as below.

In some embodiments, enhancement on two TAs for UL multi-DCI for multi-TRP operation is supported. Further, the network may signal two TACs or the network may signal one TAC and the UE may derives the second TA.

In some embodiments, support two TA enhancement for both intra-cell and inter-cell multi-DCI multi-TRP scenarios. Further, enhancements on two TAs for UL multi-DCI for multi-TRP operation are applicable to both FR1 and FR2.

In some embodiments, Two TA enhancement for uplink multi-DCI based multi-TRP operation are applicable to at least: TDM based multi-DCI uplink transmission, simultaneous multi-DCI uplink transmission (if simultaneous uplink multi-DCI uplink transmission is supported).

In some embodiments, for multi-DCI multi-TRP operation with two TAs, it is expected to study the following alternatives: considering two reference timings (i.e., timing of the DL reception), considering one reference timing.

In some embodiments, for multi-DCI multi-TRP operation with two TAs, any the following alternatives may be supported: one n-TimingAdvanceOffset value per serving cell, or two n-TimingAdvanceOffset value per serving cell.

In some embodiments, for multi-DCI based multi-TRP operation, down-select one of the two alternatives: configure two TAGs within a serving cell, or consider two TAs within one TAG within a serving cell.

In some embodiments, for multi-DCI based multi-TRP operation with two TAs, as for the overlapping part between two UL transmissions associated with two TAs, several solutions may be used, including introducing scheduling restriction in overlapping part, introducing dropping rules, and allowing overlapped transmission in case the UE supports STxMP transmission.

In some embodiments, for multi-DCI based multi-TRP operation with two TAs, two TAGs belonging to a serving cell may be configured.

In some embodiments, for multi-DCI multi-TRP operation with two TAs, up to two n-TimingAdvanceOffset value per serving cell may be supported.

In some embodiments, the multi-DCI based multi-TRP operation with two TAs may applicably for the following: RACH triggered by PDCCH order in intra-cell MTRP case, RACH triggered by PDCCH order in inter-cell MTRP case, UE triggered RACH by contention based RA (CBRA) or contention free (CFRA) in radio resource control (RRC) connected mode.

In some embodiments, for associating TAGs to target UL channels/signals for multi-DCI based multi-TRP operation, downselect one of the options:
option 1: associate TAG to TCI-state/spatial relation;
option 2: associate TAG to CORESETPoolIndex;
option 3: associate TAG to DL reference signal (RS) group. For a UL transmission, UE adopts the TAG associated with the DL RS group to which the PL RS of the UL transmission belongs;
option 4: associate TAG to target UL channels/RSs directly for semi-static UL channels/RSs (e.g. periodic CSI PUCCH, periodic SRS, configured grant (CG) PUSCH), and further discuss how to associate TAG to dynamic UL channels/RSs (e.g.
via associating TAG to CORESETPoolIndex additionally, etc.).

In some embodiments, for multi-DCI multi-TRP operation with two TAs in a CC, two DL reference timings are supported where each DL reference timing is associated with one TAG. Further, the baseline assumption is that the Rx timing difference between the two DL reference timings is no larger than CP length, and as an optional UE capability, Rx timing difference between the two DL reference timings can be assumed to be larger than CP length.

In some embodiments, for inter-cell multi-DCI based Multi-TRP operation with two TA enhancement, support one of the options: physical downlink control channel (PDCCH) scheduling RAR will always be received from serving cell è there is no need for additional type 1 common Search Space (CSS) configuration per additional PCI; and in addition to PDCCH scheduling random access response (RAR) being received from serving cell, reception of PDCCH scheduling RAR from a TRP corresponding to an additional PCI for a RACH procedure associated to the additional PCI is supported è additional type 1 CSS configuration per additional PCI needs to be supported.

In some embodiments, for multi-DCI based inter-cell multi-TRP operation with two TA enhancement, support PRACH configuration associated with additional configured PCIs different from the PCI of the serving cell.

In some embodiments, for multi-DCI based inter-cell multi-TRP operation with two TA enhancement, support a mechanism to determine which physical random access channel (PRACH) configuration (i.e., RACH configuration corresponding to serving cell PCI or an additional PCI) to be used in the RACH procedure triggered by PDCCH order.

In some embodiments, for multi-DCI based multi-TRP operation with two TA enhancement, support one of the following: 1) PDCCH order sent by one TRP triggers RACH procedure towards the same TRP, where PDCCH order sent by one TRP triggering RACH procedure towards another TRP is not allowed; 2) Alt 2: PDCCH order sent by one TRP triggers RACH procedure towards either the same TRP or a different TRP, where PDCCH order triggering two RACH procedures for two TRPs may be further supported.

In some embodiments, for associating TAGs to target UL channels/signals for multi-DCI based multi-TRP operation, the four options are refined as below:
option 1: associate TAG to TCI-state/spatial relation. Further, configure TAG identification (ID) as part of UL/joint TCI state or spatial relation, and for UL transmission, the TAG ID associated with the UL/joint TCI state or spatial relation is utilized;
option 2: associate TAG to CORESETPoolIndex. Further, for dynamically scheduled/activated PUSCH, TAG associated with the CORESET pool index of the CORESET carrying the scheduling/activating PDCCH is utilized for UL transmission. Specifically, for Type 1 CG, P/SP-SRS, and P/SP-PUCCH, CORESET pool index is RRC-configured;
option 3: associate TAG to SSB group. For a UL transmission, UE adopts the TAG associated with the SSB group such that if the PL RS is an SSB, then the UE adopts the TAG associated with the SSB group which the path loss (PL) RS of the UL transmission belongs to, and if the PL RS is a CSI-RS, then the UE adopts the TAG associated with the SSB group which the QCL source SSB of the PL RS belongs to;
option 4: TAG association performed as follows: for dynamically scheduled/activated channels/signals, TAG associated with the CORESET pool index of the CORESET carrying the scheduling PDCCH is utilized for UL transmission; for P/SP UL channels/signals (not scheduled or activated by DCI), TAG ID is RRC-configured.

In some embodiments, for multi-DCI based multi-TRP operation with two TA enhancement, support enhancements related to indicating TAG ID via absolute TA command.

In some embodiments, for multi-DCI based Multi-TRP operation with two TA enhancement, it cannot always be assumed that both TRPs have knowledge of the overlapping region between transmissions corresponding to the two TAs. Further the network may apply scheduling restrictions even if the TRPs have no knowledge of the overlapping region.

In some embodiments, for intra-cell multi-DCI based Multi-TRP operation with two TA enhancement, support at least one of the following options:
option 1: indicate TAG ID as part of TA command in RAR;
option 2: indicate TAG ID as part of PDCCH order;
option 3: divide SSBs into two groups, one for each TRP. If a SSB associated to a RACH procedure belongs to the nth group (n=1, 2), then the TA obtained via the RACH procedure corresponds to the nth TRP;
option 4: divide RACH resources into two groups, where for a RACH procedure, if the corresponding RACH resource belongs to the nth group (n=1, 2), then the TA obtained via the RACH procedure corresponds to the nth TRP;
option 5: divide preambles into two groups, where for a RACH procedure, if the corresponding preamble belongs to the nth group (n=1, 2), then the TA obtained via the RACH procedure corresponds to the nth TRP;
option 6: TAG ID is associated with CORESETPoolIndex and TAG ID is determined based on the CORESETPoolIndex of PDCCH order;
option 7: each TCI state is associated with a TAG ID, and the TAG ID corresponding to RACH triggered by a PDCCH order is determined based on the TCI state used to receive the PDCCH order.

In some embodiments, for multi-DCI based inter-cell multi-TRP operation with two TA enhancement, one additional PRACH configuration is supported for each configured additional PCI. Further, the additional PRACH configuration is used in a RACH procedure triggered by a PDCCH order for the corresponding configured additional PCI.

In some embodiments, for multi-DCI based multi-TRP operation with two TA enhancement, support CFRA triggered by PDCCH order for both intra-cell and inter-cell cases.

In some embodiments, for multi-DCI based multi-TRP operation with two TA enhancement, support the case where a PDCCH order sent by one TRP triggers RACH procedure towards either the same TRP or a different TRP at least for inter-cell multi-DCI.

In some embodiments, for multi-DCI based multi-TRP operation with two TA enhancement, there is no consensus to support enhancements for CBRA triggered by PDCCH order.

In some embodiments, for associating TAGs to target UL channels/signals for multi-DCI based multi-TRP operation, support the following: associate TAG to TCI-state; associate TAG ID with UL/joint TCI state; for UL transmission, the TAG ID associated with the UL/joint TCI state is utilized; a baseline is UE expects that the (activated) UL/joint TCI states (of UL signals/channels) associated to one CORESET Pool Index correspond to one TAG; a UE may report that it supports that the (activated) UL/joint TCI states (of UL signals/channels) associated to one CORESETPoolIndex correspond to both TAGs.

In some embodiments, for multi-DCI based inter-cell multi-TRP operation with two TA enhancement, one additional PRACH configuration is supported for each configured additional PCI, and the additional PRACH configuration is used in a RACH procedure triggered by a PDCCH order for the corresponding configured additional PCI.

In some embodiments, for multi-DCI based multi-TRP operation with two TA enhancement, for the case when the UE does not support UL STxMP transmission, down-select at least one of the following:
introducing a time gap X between two UL transmissions associated with two different TA values, where X symbols in the slot(s) corresponding to the two UL transmission remain unused;
reduce the overlapping duration of one of the two UL transmissions;
scheduling restriction is applied such that the UE does not expect the two UL transmissions to overlap.

In some embodiments, the MAC specifies the TAC received in RAR as follows.

The MAC entity shall:

| 1> | when a Timing Advance Command is received in a Random Access Response message for a Serving Cell | |
|---|---|---|
| | belonging to a TAG or in a MSGB for an SpCell: | |
| | 2> | if the Random Access Preamble was not selected by the MAC entity among the contention-based |

| Random Access Preamble: | |
|---|---|
| 3> | apply the Timing Advance Command for this TAG; |
| 3> | start or restart the timeAlignmentTimer associated with this TAG. |

| | |
|---|---|
| 2> | else if the timeAlignmentTimer associated with this TAG is not running: |

| | |
|---|---|
| 3> | apply the Timing Advance Command for this TAG; |
| 3> | start the timeAlignmentTimer associated with this TAG; |
| 3> | when the Contention Resolution is considered not successful as described in clause 5.1.5; or |
| 3> | when the Contention Resolution is considered successful for SI request as described in clause |

| 5.1.5, after transmitting HARQ feedback for MAC PDU including UE Contention Resolution | |
|---|---|
| Identity MAC CE: | |
| 4> | stop timeAlignmentTimer associated with this TAG. |

| | |
|---|---|
| 3> | when the Contention Resolution is considered not successful as described in clause 5.1.5: |

| | |
|---|---|
| 4> | if CG-SDT procedure triggered as in clause 5.27 is ongoing: |

| | |
|---|---|
| 5> | set the N_{TA} value to the value before applying the received Timing Advance Command as |

in TS 38.211 [8].

| | |
|---|---|
| 3> | when the Contention Resolution is considered successful for Random Access procedure while the |

| CG-SDT procedure is ongoing: | |
|---|---|
| 4> | stop timeAlignmentTimer associated with this TAG; |
| 4> | start or restart the cg-SDT-TimeAlignmentTimer associated with this TAG. |

| | |
|---|---|
| 3> | when the Contention Resolution is considered successful for Random Access procedure while SRS |

| transmission in RRC_INACTIVE is ongoing: | |
|---|---|
| 4> | start or restart the inactivePosSRS-TimeAlignmentTimer associated with this TAG. |

| | |
|---|---|
| 2> | else: |

| | |
|---|---|
| 3> | ignore the received Timing Advance Command. |

In other words, when UE performs CBRA procedure while in RRC_CONNECTED mode and receives a TAC over RAR (or fallbackRAR in 2-step RA procedure), the UE ignores the TAC in case the timeAlignmentTimer associated with this TAG was running already (in practice this means only primary TAG case).

Furthermore, MAC specifies the contention resolution in RRC_CONNECTED mode as follows:

Once message 3 (Msg3) is transmitted the MAC entity shall:

| 1> | if notification of a reception of a PDCCH transmission of the SpCell is received from lower layers: | |
|---|---|---|
| | 2> | if the C-RNTI MAC CE was included in Msg3: |

| 3> | if the Random Access procedure was initiated for SpCell beam failure recovery or for beam failure |
|---|---|
| | recovery of both BFD-RS sets of SpCell (as specified in clause 5.17) and the PDCCH transmission is |
| | addressed to the C-RNTI; or |
| 3> | if the Random Access procedure was initiated by a PDCCH order and the PDCCH transmission is |
| | addressed to the C-RNTI; or |
| 3> | if the Random Access procedure was initiated by the MAC sublayer itself or by the RRC sublayer |

| and the PDCCH transmission is addressed to the C-RNTI and contains a UL grant for a new | |
|---|---|
| transmission: | |
| 4> | consider this Contention Resolution successful; |
| 4> | stop ra-ContentionResolutionTimer; |
| 4> | discard the TEMPORARY_C-RNTI; |
| 4> | consider this Random Access procedure successfully completed. |

Since in the multi-TRP scenario, the UE would have 2 TAGs for a serving cell (like SpCell), these TAGS would naturally employ different TATs for the network device to be able to provide separate timing adjustment commands using, e.g., TAC MAC CE, and hence, the TATs may be (re-)started in different times for these two TAGs.

Typically, in multi-TRP scenario within a serving cell, subset of the SSBs in the cell would be transmitted by one TRP and another subset of the SSBs by another TRP. When UE performs RA procedure, it selects one of these SSBs and, hence, may transmit the PRACH preamble to either one of the TRPs.

While the UE in RRC_CONNECTED mode is configured with 2 TA-loops/TAGs for a serving cell, and more specifically for an SpCell (PCell/PSCell), CBRA may trigger at any point in time for various reasons at the UE: due to scheduling request (SR) when SR resources are not configured, number of SR transmissions reach to a configured threshold, beam failure recovery (BFR), or due to consistent listen before talk (LBT) failure detection. When RAR/message B (MSGB) or contention resolution (CR) is received providing a UL grant/PUCCH resource to the UE, it is unclear how the UE should transmit these UL messages with respect to UL timing. This can further depend on whether the TAG ID for which the RAR/MSGB/CR applies is known to the UE or not.

In case of multi-TRP, the terminal device may be configured with a serving cell, where the serving cell may be associated with more than one timing advance group (TAG). That is, more than one timing advance (TA) is configured to the terminal device Generally speaking, the terminal device may receive timing advance command (TAC) during an RA procedure, and the related transmissions may need to be performed. However, due to the above discussed multi-TA scenario, the terminal device is confused about the selection of TA. If the TA used by the terminal device is improper, the communication quality of the following RA-related transmissions will be decreased. In view of this, how to perform the RA-related transmissions with a proper TA needs to be further discussed.

According to the present disclosure, the first apparatus receives, from a second apparatus, first message indicating a first TAG corresponding to a first TA and a second TAG corresponding to a second TA, the first and second TAGs associated with a serving cell of the first apparatus and receives, during an RA procedure a second message comprising TAC indicating a third TA. Then, the first apparatus performs RA-related transmissions by using the third TA or by using a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In this way, it may be ensured that the first apparatus may use a correct/proper timing adjustment value in UL transmission happening/triggered in the RA procedure, such that the second apparatus may be able to decode them.

In the following, a special cell (SpCell) is used as an example serving cell only for the purpose of illustration without suggesting any limitations.

Further, in the following, two TAGs/TAs will be used as an example scenario for describing some specific example embodiments of the present disclosure. It should be understood that the embodiment descried herein may be suitable to the scenario where more than two TAGs/TAs are configured.

Principles and implementations of the present disclosure will be described in detail below with reference to the figures.

### Example Environment

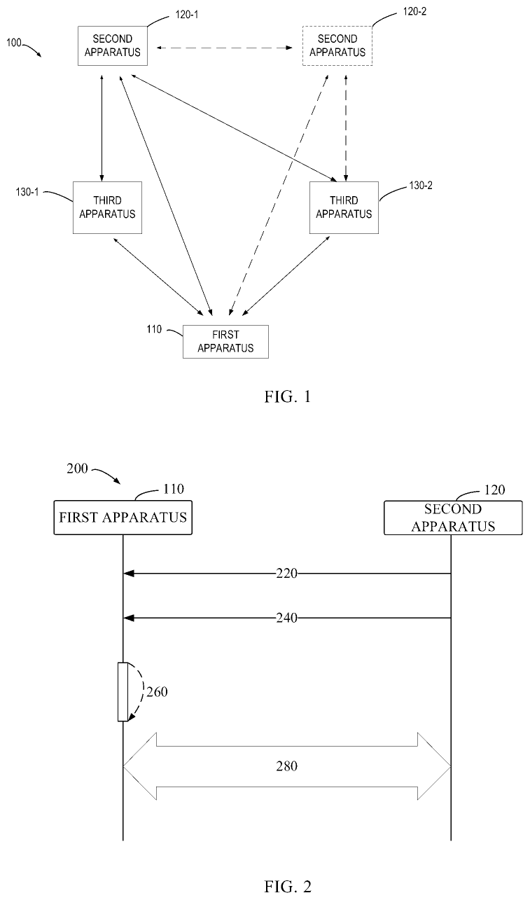

FIG. 1 illustrates an example communication environment 100 in which example embodiments of the present disclosure can be implemented. The communication network 100 includes a second apparatus 120-1 and an optionally second apparatus 120-2 (collectively or individually referred to as second apparatus 120). Further, the second apparatus 120-1 and the second apparatus 120-2 can communicate with each other. The second apparatus 120 can provide services to a first apparatus 110.

In the following, for the purpose of illustration, some example embodiments are described with the first apparatus 110 operating as a UE and the second apparatus 120 operating as a base station. However, in some example embodiments, operations described in connection with a first apparatus may be implemented at a second apparatus or other device, and operations described in connection with a second apparatus may be implemented at a first apparatus or other device.

If the first apparatus 110 is a UE and the second apparatus 120 is base station, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) apparatus (or a transmitter) and the first apparatus 110 is a receiving (RX) apparatus (or a receiver). In UL, the apparatus device 110 is a TX device (or a transmitter) and the apparatus device 120 is a RX device (or a receiver).

In FIG. 1, the second apparatus 120 may be equipped with one or more third apparatus 130 to extend the coverage. For example, the second apparatus 120 may be coupled with multiple TRPs in different geographical locations to achieve better coverage. In one specific example embodiment, the first second apparatus 120-1 is equipped with the third apparatuses 130-1 and 130-2. Alternatively, in another specific example embodiment, the second apparatus 120-1 and the second apparatus 120-2 may be equipped with the third apparatuses 130-1 and 130-2, respectively.

Further, the second apparatus(s) 120 may provide one or more cells (or cell groups) and the first TRP 130-1 and the second TRP 130-2 may be included in a same cell (or cell group) or different cells (or cell groups).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for RA-related transmissions.

Reference is made to FIG. 2, which illustrates a signaling flow 200 of communication in accordance with some embodiments of the present disclosure. For the purposes of discussion, the signaling flow 200 will be discussed with reference to FIG. 1, for example, by using the first apparatus 110 and the second apparatus 120.

It is to be understood that the operations at the first apparatus 110 and the second apparatus 120 should be coordinated. In other words, the second apparatus 120 and the first apparatus 110 should have common understanding about configurations, parameters and so on. Such common understanding may be implemented by any suitable interactions between the second apparatus 120 and the first apparatus 110 or both the second apparatus 120 and the first apparatus 110 applying the same rule/policy. In the following, although some operations are described from a perspective of the first apparatus 110, it is to be understood that the corresponding operations should be performed by the second apparatus 120. Similarly, although some operations are described from a perspective of the second apparatus 120, it is to be understood that the corresponding operations should be performed by the first apparatus 110. Merely for brevity, some of the same or similar contents are omitted here.

In operation, the first apparatus 110 receives 220 a first message, where the first message indicates a first TAG corresponding to a first TA and a second TAG corresponding to a second TA, the first and second TAGs associated with a serving cell (such as, SpCell) of the first apparatus 110.

The first apparatus 110 further receives 240 a second message comprising a TAC indicating a third TA during an RA procedure. Then, the first apparatus 110 performs 280 RA-related transmissions.

In some example embodiments, the second message is one of the following: an RAR during a 4-step RA procedure, a fallback RAR for message A during a 2-step RA procedure, a success response for message A during a 2-step RA procedure, or a MAC CE comprising an absolute TA.

In some example embodiments, the RA-related transmissions comprise at least one of the following: transmissions or re-transmissions of message 3 during the RA procedure; PUSCH scheduled by a contention resolution message in the RA procedure (i.e., PDCCH transmission is addressed to the C-RNTI and contains a UL grant for a new transmission), or PUCCH transmission in response to contention resolution message in the RA procedure (i.e., if a downlink assignment has been received on the PDCCH for the C-RNTI and the received TB is successfully decoded).

In some embodiments, the RA-related transmissions are performed by using the third TA directly. As one specific example embodiments, the SpCell is configured with two TAGs and CBRA procedure is triggered. The first apparatus 110 applies the TAC received regardless of the running status of the multiple time alignment timer (TAT) s associated with the SpCell.

Alternatively, the RA-related transmissions are performed by using a TA selected from the first, second and third TAs based on at least one of the following: a first status of a first alignment timer associated with the first TAG, a second status of a first alignment timer associated with the second TAG, or a TAG identity indicated to the first apparatus 110 during the RA, the TAG identity associated with either the first TAG or the second TAG. Some example embodiments are described below.

In some example embodiments, if the second message further indicates the TAG identity corresponding to the first TAG, and the first status of the first alignment timer is running, the first apparatus 110 may ignore the TAC and/or perform the RA-related transmissions by using the first TA.

As one specific embodiment, the TAG ID associated with the preamble transmission is indicated to the first apparatus 110 within the RA procedure (e.g., in RAR/fallbackRAR/MSGB). If the TAT associated with the indicated TAG ID is running, the first apparatus 110 may ignore the TAC and apply the timing (i.e., TA) associated with the indicated TAG ID for the Msg3 transmission and/or the PUSCH/PUCCH transmission scheduled by the successful contention resolution message.

In some example embodiments, if the second message further indicates the TAG identity corresponding to the first TAG, and the first status of the first alignment timer is running, the first apparatus 110 may perform the RA-related transmissions by using the third TA and ignores the TAC after the RA-related transmissions.

As one specific embodiment, the TAG ID associated with the preamble transmission is indicated to the first apparatus 110 within the RA procedure (e.g., in RAR/fallbackRAR/MSGB). If the TAT associated with the indicated TAG ID is running, the first apparatus 110 may ignore the TAC after the PUSCH/PUCCH transmission scheduled by the successful contention resolution message or after considering contention resolution successful if the TAT associated with the indicated TAG ID is running.

In some example embodiments, if the second message further indicates the TAG corresponding to the first TAG, and the first status of the first alignment timer is not running, the first apparatus 110 may perform the RA-related transmissions by using the third TA (i.e., applying the TAC). Additionally, the first apparatus 110 may (re) start the first alignment timer.

As one specific embodiment, if the TAT associated with the indicated TAG ID is not running, the first apparatus 110 may apply the TAC and (re-)starts the TAT associated with the TAG ID.

In some example embodiments, if a contention resolution of the RA procedure is failed, the first apparatus 110 may stop the first alignment timer.

As one specific embodiment, when the contention resolution is not successful (for example, ra-ContentionResolutionTimer expires or the contention resolution ID does not match with UE contention resolution identity), if the TAT associated with the indicated TAG ID was not running and was (re-)started upon receiving the TAC in RAR/fallbackRAR, the TAT is stopped. In one example implementation of this embodiment, when the contention resolution is not successful (ra-ContentionResolutionTimer expires or the contention resolution ID does not match with UE contention resolution identity), if the TAC was not ignored upon receiving the RAR/fallbackRAR, the TAT is stopped.

In some example embodiments, if a preamble used in the RA procedure associates with a PCI corresponding to the first TAG, and the first status of the first alignment timer is not running, the first apparatus 110 may perform the RA-related transmissions by using the third TA (i.e., applying the TAC). Additionally, the first apparatus 110 may (re) start the first alignment timer.

As one specific embodiment, if the UE selects a preamble corresponding to an SSB which is associated to a PCI for the PRACH transmission, and this PCI corresponds to a TAG ID: if the TAT of this TAG ID is not running, the UE applies the indicated TAC in RAR or MSGB considering the TAG ID and (re-)starts the TAT associated to the TAG ID, regardless of which TAG ID is indicated within the RA procedure.

In some example embodiments, if a preamble used in the RA procedure associates with a PCI corresponding to the first TAG, and the first status of the first alignment timer is running, the first apparatus 110 may perform the RA-related transmissions by using the first TA (i.e., ignore the TAC).

In some example embodiments, if the TAG identity is not indicated to the first apparatus 110 during the RA, the first apparatus 110 may perform the RA-related transmissions by temporarily using the third TA (such as, ignoring the TAC after the RA-related transmissions).

As one specific embodiment, the TAG ID associated with the preamble transmission is not indicated to the UE within the RA procedure. In one example embodiment, the first apparatus 110 may ignore the TAC after the PUSCH/PUCCH transmission scheduled by the successful contention resolution message or after considering contention resolution successful, i.e., the TAC in RAR/MSGB is only temporarily used for MSG3 and PUSCH/PUCCH transmissions in response to RAR/MSGB, thus, the first apparatus 110 may does not need to be aware of which TRP the TAC in the RAR/MSGB is intended for.

In some example embodiments, performing the RA-related transmissions by temporarily using the third TA comprises: starting a third timer upon receiving the second message, and stopping the third timer upon a completion of the RA-related transmissions or a failure of a contention resolution of the RA procedure, wherein the TAC is valid if the third timer is running. Additionally, in some example embodiments, the first message further indicates a configuration of the third timer.

As one specific embodiment, the first apparatus 110 may start a “RA-TAT” (Random Access Timing Alignment Timer, i.e., the third timer) upon receiving the TAC in RAR or MSGB for the purpose of transmitting the MSG3 and/or PUSCH/PUCCH transmissions associated with the RA procedure. The RA-TAT can be stopped after the transmission of the PUSCH/PUCCH scheduled by the successful contention resolution message or upon determining the contention resolution as not successful. Additionally, in one example, the second apparatus 120 configures the RA-TAT to the UE upon configuring the UE with multiple TAGs for the SpCell.

In some example embodiments, the first apparatus 110 may disable updating a TA configuration associated with any of the first and second TAGs (i.e., keeping a current TA configuration associated with both of the first and second TAGs).

As one specific embodiment, the status of NTA/TATs associated with the TAGs of SpCell are not affected, i.e., if one of the TATs was not running, it is not started by means of receiving the TAC in RAR/MSGB.

As another specific embodiment, if for the PRACH transmission the first apparatus 110 may select a preamble corresponding to an SSB which is associated to a PCI, and this PCI corresponds to a TAG ID: if the TAT of this TAG ID is not running, the UE applies the indicated TAC in RAR or MSGB and (re-)starts the TAT associated to the TAG ID.

### Example Methods

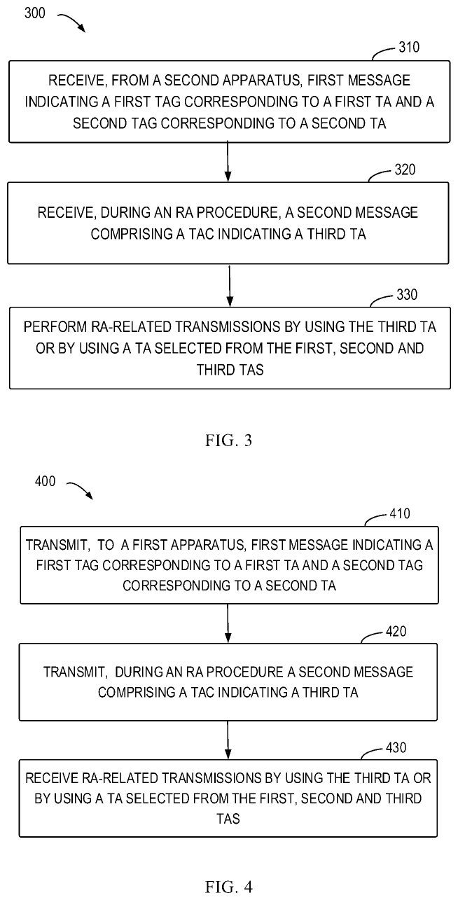

FIG. 3 shows a flowchart of an example method 300 implemented at a first device in accordance with some example embodiments of the present disclosure. For the purpose of discussion, the method 300 will be described from the perspective of the first apparatus 110 in FIG. 1.

At block 310, the first apparatus receives from a second apparatus, first message indicating a first TAG corresponding to a first TA and a second TAG corresponding to a second TA, the first and second TAGs associated with a serving cell of the first apparatus.

At block 320, the first apparatus receives during an RA procedure a second message comprising a TAC indicating a third TA.

At block 330, the first apparatus performs RA-related transmissions by using the third TA or by using a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In some example embodiments, the second message is one of the following: a RAR during a 4-step RA procedure, a fallback RAR for message A during a 2-step RA procedure, a success response for message A during a 2-step RA procedure, or a MAC CE comprising an absolute TA.

In some example embodiments, the RA-related transmissions comprise at least one of the following: transmissions or re-transmissions of message 3 during the RA procedure; PUSCH scheduled by a contention resolution message in the RA procedure, or PUCCH transmission in response to contention resolution message in the RA procedure.

In some example embodiments, if the second message further indicates the TAG identity corresponding to the first TAG, and the first status of the first alignment timer is running, performing the RA-related transmissions comprises at least one of the following: ignoring the TAC; or performing the RA-related transmissions by using the first TA.

In some example embodiments, if the second message further indicates the TAG identity corresponding to the first TAG, and the first status of the first alignment timer is running, performing the RA-related transmissions comprises at least one of the following: performing the RA-related transmissions by using the third TA; or ignoring the TAC after the RA-related transmissions.

In some example embodiments, if the second message further indicates the TAG corresponding to the first TAG, and the first status of the first alignment timer is not running, performing the RA-related transmissions comprises at least one of the following: performing the RA-related transmissions by using the third TA; applying the TAC; or starting the first alignment timer.

In some example embodiments, the at least one memory and the at least one processor further cause the first apparatus to perform: if a contention resolution of the RA procedure is failed, stopping the first alignment timer.

In some example embodiments, if a preamble used in the RA procedure associates with a PCI corresponding to the first TAG, and the first status of the first alignment timer is not running, performing the RA-related transmissions comprises at least one of the following: performing the RA-related transmissions by using the third TA; applying the TAC; or starting the first alignment timer.

In some example embodiments, if a preamble used in the RA procedure associates with a PCI corresponding to the first TAG, and the first status of the first alignment timer is running, performing the RA-related transmissions comprises at least one of the following: ignoring the TAC; or performing the RA-related transmissions by using the first TA.

In some example embodiments, if the TAG identity is not indicated to the first apparatus during the RA, performing the RA-related transmissions comprises at least one of the following: performing the RA-related transmissions by temporarily using the third TA; or ignoring the TAC after the RA-related transmissions.

In some example embodiments, performing the RA-related transmissions by temporarily using the third TA comprises: starting a third timer upon receiving the second message; and stopping the third timer upon a completion of the RA-related transmissions or a failure of a contention resolution of the RA procedure, wherein the TAC is valid if the third timer is running.

In some example embodiments, the first message further indicates a configuration of the third timer.

In some example embodiments, the first apparatus disables updating a TA configuration associated with any of the first and second TAGs; or keeps a current TA configuration associated with both of the first and second TAGs.

In some example embodiments, the first apparatus is a terminal apparatus and the second apparatus is a network apparatus.

FIG. 4 shows a flowchart of an example method 400 implemented at a second device in accordance with some example embodiments of the present disclosure. For the purpose of discussion, the method 400 will be described from the perspective of the second apparatus 120 in FIG. 1.

At block 410, the second apparatus transmits, to a first apparatus, first message indicating a first TAG corresponding to a first TA and a second TAG corresponding to a second TA, the first and second TAGs associated with a serving cell of the first apparatus.

At block 420, the second apparatus transmits, during an RA procedure, a second message comprising a TAC indicating a third TA.

At block 430, the second apparatus receives RA-related transmissions by using the third TA or a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In some example embodiments, the second message is one of the following: a RAR during a 4-step RA procedure, a fallback RAR for message A during a 2-step RA procedure, or a success response for message A during a 2-step RA procedure.

In some example embodiments, where in the RA-related transmissions comprise at least one of the following: transmissions or re-transmissions of message 3 during the RA procedure; PUSCH scheduled by a contention resolution message in the RA procedure, or PUCCH transmission in response to contention resolution message in the RA procedure.

In some example embodiments, if the second message further indicates the TAG identity corresponding to the first TAG, and the first status of the first alignment timer is running, receiving the RA-related transmissions comprises at least one of the following: ignoring the TAC; or receiving the RA-related transmissions by using the first TA.

In some example embodiments, if the second message further indicates the TAG identity corresponding to the first TAG, and the first status of the first alignment timer is running, receiving the RA-related transmissions comprises at least one of the following: receiving the RA-related transmissions by using the third TA; or ignoring the TAC after the RA-related transmissions.

In some example embodiments, if the second message further indicates the TAG corresponding to the first TAG, and the first status of the first alignment timer is not running, receiving the RA-related transmissions comprises at least one of the following: receiving the RA-related transmissions by using the third TA; applying the TAC; or starting the first alignment timer.

In some example embodiments, if a contention resolution of the RA procedure is failed, stopping the first alignment timer.

In some example embodiments, if a preamble used in the RA procedure associates with a PCI corresponding to the first TAG, and the first status of the first alignment timer is not running, receiving the RA-related transmissions comprises at least one of the following: receiving the RA-related transmissions by using the third TA; applying the TAC; or starting the first alignment timer.

In some example embodiments, if a preamble used in the RA procedure associates with a PCI corresponding to the first TAG, and the first status of the first alignment timer is running, receiving the RA-related transmissions comprises at least one of the following: ignoring the TAC; or receiving the RA-related transmissions by using the first TA.

In some example embodiments, if the TAG identity is not indicated to the first apparatus during the RA, receiving the RA-related transmissions comprises at least one of the following: receiving the RA-related transmissions by temporarily using the third TA; or ignoring the TAC after the RA-related transmissions.

In some example embodiments, receiving the RA-related transmissions by using the third TA temporarily comprises: starting a third timer upon receiving the second message; and stopping the third timer upon a completion of the RA-related transmissions or a failure of a contention resolution of the RA procedure, wherein the TAC is valid if the third timer is running.

In some example embodiments, the first message further indicates a configuration of the third timer.

In some example embodiments, the second apparatus disables updating a TA configuration associated with any of the first and second TAGs; or keeps a current TA configuration associated with both of the first and second TAGs.

In some example embodiments, the first apparatus is a terminal apparatus and the second apparatus is a network apparatus.

### Example Apparatus, Device and Medium

In some example embodiments, a first apparatus capable of performing any of the method 300 (for example, the first apparatus 110 in FIG. 1) may comprise means for performing the respective operations of the method 300. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, first message indicating a first TAG corresponding to a first TA and a second TAG corresponding to a second TA, the first and second TAGs associated with a serving cell of the first apparatus; means for receiving, during an RA procedure a second message comprising a TAC indicating a third TA; means for performing RA-related transmissions by using the third TA or by using a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In some example embodiments, the second message is one of the following: a RAR during a 4-step RA procedure, a fallback RAR for message A during a 2-step RA procedure, a success response for message A during a 2-step RA procedure, or a MAC CE comprising an absolute TA.

In some example embodiments, the RA-related transmissions comprise at least one of the following: transmissions or re-transmissions of message 3 during the RA procedure; PUSCH scheduled by a contention resolution message in the RA procedure, or PUCCH transmission in response to contention resolution message in the RA procedure.

In some example embodiments, if the second message further indicates the TAG identity corresponding to the first TAG, and the first status of the first alignment timer is running, means for performing the RA-related transmissions comprises at least one of the following: means for ignoring the TAC; or means for performing the RA-related transmissions by using the first TA.

In some example embodiments, if the second message further indicates the TAG identity corresponding to the first TAG, and the first status of the first alignment timer is running, means for performing the RA-related transmissions comprises at least one of the following: means for performing the RA-related transmissions by using the third TA; or means for ignoring the TAC after the RA-related transmissions.

In some example embodiments, if the second message further indicates the TAG corresponding to the first TAG, and the first status of the first alignment timer is not running means for performing the RA-related transmissions comprises at least one of the following: means for performing the RA-related transmissions by using the third TA; means for applying the TAC; or means for starting the first alignment timer.

In some example embodiments, the first apparatus further comprises means for if a contention resolution of the RA procedure is failed, stopping the first alignment timer.

In some example embodiments, if a preamble used in the RA procedure associates with a PCI corresponding to the first TAG, and the first status of the first alignment timer is not running means for performing the RA-related transmissions comprises at least one of the following: means for performing the RA-related transmissions by using the third TA; means for applying the TAC; or means for starting the first alignment timer.

In some example embodiments, if a preamble used in the RA procedure associates with a PCI corresponding to the first TAG, and the first status of the first alignment timer is running means for performing the RA-related transmissions comprises at least one of the following: means for ignoring the TAC; or means for performing the RA-related transmissions by using the first TA.

In some example embodiments, if the TAG identity is not indicated to the first apparatus during the RA means for performing the RA-related transmissions comprises at least one of the following: means for performing the RA-related transmissions by temporarily using the third TA; or means for ignoring the TAC after the RA-related transmissions.

In some example embodiments, means for performing the RA-related transmissions by temporarily using the third TA comprises: means for starting a third timer upon receiving the second message; and means for stopping the third timer upon a completion of the RA-related transmissions or a failure of a contention resolution of the RA procedure, wherein the TAC is valid if the third timer is running.

In some example embodiments, the first message further indicates a configuration of the third timer.

In some example embodiments, the first apparatus further comprises means for disabling updating a TA configuration associated with any of the first and second TAGs; or means for keeping a current TA configuration associated with both of the first and second TAGs.

In some example embodiments, the first apparatus is a terminal apparatus and the second apparatus is a network apparatus.

In some example embodiments, the first apparatus further comprises means for performing other operations in some example embodiments of the method 300 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 400 (for example, the second apparatus 120 in FIG. 1 may comprise means for performing the respective operations of the method 400. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, first message indicating a first TAG corresponding to a first TA and a second TAG corresponding to a second TA, the first and second TAGs associated with a serving cell of the first apparatus; means for transmitting, during an RA procedure, a second message comprising a TAC indicating a third TA; means for receiving RA-related transmissions by using the third TA or a TA selected from the first, second and third TAs based on at least one of the following: a first status of a first alignment timer associated with the first TAG, a second status of a first alignment timer associated with the second TAG, or a TAG identity indicated to the first apparatus during the RA, the TAG identity associated with either the first TAG or the second TAG.

In some example embodiments, the second message is one of the following: a RAR during a 4-step RA procedure, a fallback RAR for message A during a 2-step RA procedure, or a success response for message A during a 2-step RA procedure.

In some example embodiments, where in the RA-related transmissions comprise at least one of the following: transmissions or re-transmissions of message 3 during the RA procedure; PUSCH scheduled by a contention resolution message in the RA procedure, or PUCCH transmission in response to contention resolution message in the RA procedure.

In some example embodiments, if the second message further indicates the TAG identity corresponding to the first TAG, and the first status of the first alignment timer is running means for receiving the RA-related transmissions comprises at least one of the following: means for ignoring the TAC; or means for receiving the RA-related transmissions by using the first TA.

In some example embodiments, if the second message further indicates the TAG identity corresponding to the first TAG, and the first status of the first alignment timer is running means for receiving the RA-related transmissions comprises at least one of the following: means for receiving the RA-related transmissions by using the third TA; or means for ignoring the TAC after the RA-related transmissions.

In some example embodiments, if the second message further indicates the TAG corresponding to the first TAG, and the first status of the first alignment timer is not running means for receiving the RA-related transmissions comprises at least one of the following: means for receiving the RA-related transmissions by using the third TA; means for applying the TAC; or means for starting the first alignment timer.

In some example embodiments, the second apparatus further comprises: means for if a contention resolution of the RA procedure is failed, stopping the first alignment timer.

In some example embodiments, if a preamble used in the RA procedure associates with a PCI corresponding to the first TAG, and the first status of the first alignment timer is not running means for receiving the RA-related transmissions comprises at least one of the following: means for receiving the RA-related transmissions by using the third TA; means for applying the TAC; or means for starting the first alignment timer.

In some example embodiments, if a preamble used in the RA procedure associates with a PCI corresponding to the first TAG, and the first status of the first alignment timer is running means for receiving the RA-related transmissions comprises at least one of the following: means for ignoring the TAC; or means for receiving the RA-related transmissions by using the first TA.

In some example embodiments, if the TAG identity is not indicated to the first apparatus during the RA, means for receiving the RA-related transmissions comprises at least one of the following: means for receiving the RA-related transmissions by temporarily using the third TA; or means for ignoring the TAC after the RA-related transmissions.

In some example embodiments, means for receiving the RA-related transmissions by using the third TA temporarily comprises: means for starting a third timer upon receiving the second message; and means for stopping the third timer upon a completion of the RA-related transmissions or a failure of a contention resolution of the RA procedure, wherein the TAC is valid if the third timer is running.

In some example embodiments, the first message further indicates a configuration of the third timer.

In some example embodiments, the second apparatus further comprises: means for disabling updating a TA configuration associated with any of the first and second TAGS; or means for keeping a current TA configuration associated with both of the first and second TAGs.

In some example embodiments, the first apparatus is a terminal apparatus and the second apparatus is a network apparatus.

In some example embodiments, the second apparatus further comprises means for receiving other operations in some example embodiments of the method 400 or the second apparatus 120. In some example embodiments, the means comprises at least one processor; and at least one memory storing instructions that, when executed by the at least one processor, cause the performance of the second apparatus.

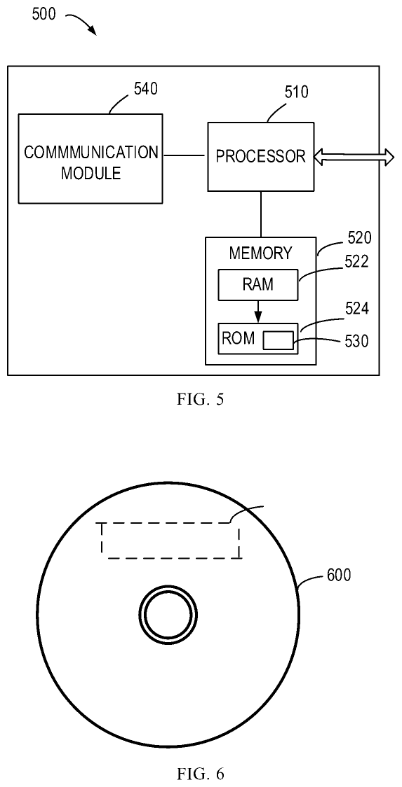

FIG. 5 is a simplified block diagram of a device 500 that is suitable for implementing example embodiments of the present disclosure. The device 500 may be provided to implement a communication device, for example, the first apparatus 110 or the second apparatus 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A first apparatus comprising:
at least one processor; and
at least one memory storing instructions that, when executed by the at least one processor, cause the first apparatus at least to perform:
receiving, from a second apparatus, a first message indicating a first timing advance group (TAG) corresponding to a first timing advance (TA) and a second TAG corresponding to a second TA, the first and second TAGs associated with a serving cell of the first apparatus;
receiving, during a random access (RA) procedure a second message comprising a timing advance command (TAC) indicating a third TA;
performing RA-related transmissions by using the third TA or by using a TA selected from the first, second and third TAs based on at least one of the following:
a first status of a first alignment timer associated with the first TAG,
a second status of a first alignment timer associated with the second TAG, or
a TAG identity indicated to the first apparatus during the RA, the TAG identity associated with either the first TAG or the second TAG.

33. The first apparatus of claim 32, wherein the second message is one of the following:
a random access response (RAR) during a 4-step RA procedure,
a fallback RAR for message A during a 2-step RA procedure,
a success response for message A during a 2-step RA procedure, or
a medium access control (MAC) control element (CE) comprising an absolute TA.

34. The first apparatus of claim 32, wherein the RA-related transmissions comprise at least one of the following:
transmissions or re-transmissions of message 3 during the RA procedure;
physical uplink shared channel (PUSCH) scheduled by a contention resolution message in the RA procedure, or
physical uplink control channel (PUCCH) transmission in response to contention resolution message in the RA procedure.

35. The first apparatus of claim 32, wherein if the second message further indicates the TAG identity corresponding to the first TAG, and the first status of the first alignment timer is running, performing the RA-related transmissions comprises at least one of the following:
ignoring the TAC; or
performing the RA-related transmissions by using the first TA.

36. The first apparatus of claim 32, wherein if the second message further indicates the TAG identity corresponding to the first TAG, and the first status of the first alignment timer is running, performing the RA-related transmissions comprises at least one of the following:
performing the RA-related transmissions by using the third TA; or
ignoring the TAC after the RA-related transmissions.

37. The first apparatus of claim 32, wherein if the second message further indicates the TAG corresponding to the first TAG, and the first status of the first alignment timer is not running, performing the RA-related transmissions comprises at least one of the following:
performing the RA-related transmissions by using the third TA;
applying the TAC; or
starting the first alignment timer.

38. The first apparatus of claim 37, wherein the at least one memory and the at least one processor further cause the first apparatus to perform:
if a contention resolution of the RA procedure is failed, stopping the first alignment timer.

39. The first apparatus of claim 32, wherein if a preamble used in the RA procedure associates with a physical cell identity (PCI) corresponding to the first TAG, and the first status of the first alignment timer is not running, performing the RA-related transmissions comprises at least one of the following:
performing the RA-related transmissions by using the third TA;
applying the TAC; or
starting the first alignment timer.

40. The first apparatus of claim 32, wherein if a preamble used in the RA procedure associates with a physical cell identity (PCI) corresponding to the first TAG, and the first status of the first alignment timer is running, performing the RA-related transmissions comprises at least one of the following:
ignoring the TAC; or
performing the RA-related transmissions by using the first TA.

41. The first apparatus of claim 32, wherein if the TAG identity is not indicated to the first apparatus during the RA, performing the RA-related transmissions comprises at least one of the following:
performing the RA-related transmissions by temporarily using the third TA; or
ignoring the TAC after the RA-related transmissions.

42. The first apparatus of claim 41, wherein performing the RA-related transmissions by temporarily using the third TA comprises:
starting a third timer upon receiving the second message; and
stopping the third timer upon a completion of the RA-related transmissions or a failure of a contention resolution of the RA procedure, wherein the TAC is valid if the third timer is running.

43. The first apparatus of claim 41, wherein the first message further indicates a configuration of the third timer.

44. The first apparatus of claim 41, wherein the at least one memory and the at least one processor further cause the first apparatus to perform:
disabling updating a TA configuration associated with any of the first and second TAGs; or
keeping a current TA configuration associated with both of the first and second TAGs.

45. The first apparatus of claim 32, wherein the first apparatus is a terminal apparatus and the second apparatus is a network apparatus.

46. A second apparatus comprising:
at least one processor; and
at least one memory storing instructions that, when executed by the at least one processor, cause the second apparatus at least to perform:
transmitting, to a first apparatus, first message indicating a first timing advance group (TAG) corresponding to a first timing advance (TA) and a second TAG corresponding to a second TA, the first and second TAGs associated with a serving cell of the first apparatus;
transmitting, during a random access (RA) procedure, a second message comprising a timing advance command (TAC) indicating a third TA;
receiving RA-related transmissions by using the third TA or a TA selected from the first, second and third TAs based on at least one of the following:
a first status of a first alignment timer associated with the first TAG,
a second status of a first alignment timer associated with the second TAG, or
a TAG identity indicated to the first apparatus during the RA, the TAG identity associated with either the first TAG or the second TAG.

47. The second apparatus of claim 46, wherein the second message is one of the following:
a random access response (RAR) during a 4-step RA procedure,
a fallback RAR for message A during a 2-step RA procedure,
a success response for message A during a 2-step RA procedure, or
a medium access control (MAC) control element (CE) comprising an absolute TA.

48. The second apparatus of claim 46, where in the RA-related transmissions comprise at least one of the following:
transmissions or re-transmissions of message 3 during the RA procedure;
physical uplink shared channel (PUSCH) scheduled by a contention resolution message in the RA procedure, or
physical uplink control channel (PUCCH) transmission in response to contention resolution message in the RA procedure.

49. The second apparatus of claim 46, wherein if the second message further indicates the TAG identity corresponding to the first TAG, and the first status of the first alignment timer is running, receiving the RA-related transmissions comprises at least one of the following:
ignoring the TAC; or
receiving the RA-related transmissions by using the first TA.

50. The second apparatus of claim 46, wherein if the second message further indicates the TAG identity corresponding to the first TAG, and the first status of the first alignment timer is running, receiving the RA-related transmissions comprises at least one of the following:
receiving the RA-related transmissions by using the third TA; or
ignoring the TAC after the RA-related transmissions.

51. A method comprising:
receiving, at a first apparatus, from a second apparatus, a first message indicating a first timing advance group (TAG) corresponding to a first timing advance (TA) and a second TAG corresponding to a second TA, the first and second TAGs associated with a serving cell of the first apparatus;
receiving, during a random access (RA) procedure a second message comprising a timing advance command (TAC) indicating a third TA;
performing RA-related transmissions by using the third TA or by using a TA selected from the first, second and third TAs based on at least one of the following:
a first status of a first alignment timer associated with the first TAG,
a second status of a first alignment timer associated with the second TAG, or
a TAG identity indicated to the first apparatus during the RA, the TAG identity associated with either the first TAG or the second TAG.
